(19) United States
(12) Patent Application Publication
(10) Pub. No.: US 2010/0134623 A1
(43) Pub. Date: Jun. 3, 2010

(54) Method of processing continuously recorded image, computer-readable medium for processing continuously recorded image, drive recorder and reproduction device

(75) Inventors: Masayuki Sakaguchi, Kobe-shi (JP); Kohhei Ono, Kobe-shi (JP); Masahiro Motojima, Kobe-shi (JP); Takahiro Takebe, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/591,446

(22) Filed: Nov. 19, 2009

(30) Foreign Application Priority Data
Nov. 28, 2008 (JP) 2008-305562

(51) Int. Cl. H04N 7/18; H04N 7/26

(52) U.S. Cl. 348/148; 386/124; 348/E07.085

(57) ABSTRACT

A method of processing a continuously recorded image, with the use of a computer, comprising the steps of: judging whether a continuously recorded image is recorded at a certain interval, and storing the continuously recorded image as a data file when the continuously recorded image is stored at a certain interval.

This application is a new U.S. patent application that claims priority of Japanese Application No. 2008-305562, filed Nov. 28, 2008, the content, thereof is incorporated herein by reference.

### FIELD OF INVENTION

This invention relates to a method of processing an image which is continuously recorded while an accessory switch (ACC switch) of a vehicle is on, or processing an image which is recorded in the period of time between one operation by a user and another operation by a user or during a given period of time from an operation by a user, a computer-readable medium for processing continuously recorded image, a drive recorder and a reproduction device.

### BACKGROUND OF THE INVENTION

Conventionally, a vehicle-mounted image recording device known as a drive recorder has been proposed, which picks up an image of the surroundings of a vehicle by a camera installed in the vehicle, and records an image and vehicle speed when impact is applied to the vehicle due to a collision or rapid braking. When the drive recorder is provided in a vehicle, it is possible to verify the circumstances of an accident by analyzing the recorded information. The drive recorder can also raise a driver's consciousness with regard to safe driving, and provide a recorded image of daily driving to help improve driving safety.

A drive recorder that cyclically records images captured by a vehicle-mounted camera, and records images stored at the time of an accident onto a separate recording medium has been proposed (for example, Patent Documents 1 and 2). A drive recorder that cyclically records data, such as vehicle speed and gear shift position, and records the data stored at the time of an accident onto a separate recording medium has been proposed (for example, Patent Documents 3 and 4).

### Patent Document 1: JP S63-16785-A

### Patent Document 2: JP H06-234763-A

### Patent Document 3: JP H06-331391-A

### Patent Document 4: JP H06-186061-A

### SUMMARY OF THE INVENTION

The drive recorder can continually record an image of the outside of the vehicle on a recording medium, when the accessory switch of the vehicle is on. However, the recording time of the continuously recorded image is extremely long, and accordingly it is difficult to specify a portion of the recorded image in the continuously recorded image. Further, a plurality of events, such as rapid acceleration occurs while the vehicle is moving. If an image of one of the events is needs to be viewed, all of the images of the events have to be viewed in order to select the required image. Therefore, according to the conventional art, it is difficult to find a desired image within a short period of time.

It is an object of the present invention to provide a method of processing a continuously recorded image which enables a user to easily find a desired image in the continuously recorded image.

A method of processing a continuously recorded image according to the present invention, with the use of a computer, comprises the steps of judging whether a continuously recorded image is recorded by a vehicle-mounted device at a certain interval, and storing the continuously recorded image as a data file when the continuously recorded image is recorded at a certain interval. A computer-readable medium for processing a continuously recorded image according to the present invention, with the use of a computer, comprises the steps of: judging whether a continuously recorded image is recorded at a certain interval, and storing the continuously recorded image as a data file when the continuously recorded image is recorded at a certain interval. A drive recorder according to the present invention comprises a computer for processing a continuously recorded image: the computer judging whether a continuously recorded image is recorded at a certain interval, and storing the continuously recorded image as a data file when the continuously recorded image is recorded at a certain interval.

According to a second embodiment of the present invention, there is provided a method of processing a continuously recorded image, with the use of a computer, comprising the steps of extracting events of a continuously recorded image recorded by a vehicle-mounted device, and making a list of the events. A computer-readable medium for processing a continuously recorded image according to the present invention, with the use of a computer, comprises the steps of: extracting events of a continuously recorded image recorded by a vehicle-mounted device, and making a list of the events. A reproduction device according to the present invention comprises a computer for processing a continuously recorded image: the computer extracting events of a continuously recorded image recorded by a vehicle-mounted device, and making a list of the events.

According to the method of processing a continuously recorded image of the present invention the computer-readable medium for processing continuously recorded image of the invention, and the drive recorder of the present invention, the computer stores the continuously recorded image as a data file when the continuously recorded image is recorded in a certain interval. By storing the continuously recorded image as a data file, the continuously recorded image can be managed based on the data file, and thereby a user can easily find a desired image in the continuously recorded image.

In the method of processing a continuously recorded image according to the second embodiment of the present invention, the computer-readable medium for processing continuously recorded image according to the second embodiment of the present invention, and the drive recorder according to the present invention, as described above the events of the continuously recorded image recorded by the vehicle-mounted device are extracted and a list of the events is made. Therefore, by referring to the list of the events, a user can easily find a desired image in the continuously recorded image.

### DESCRIPTION OF THE DRAWINGS

These and other features and advantages of the present invention will be better understood by reading the following detailed description, taken together with the drawings wherein:

FIG. 1 is a diagram showing an example of a drive recorder mounted on a vehicle.

FIG. 2 is a diagram showing an example of the drive recorder installed in a vehicle.

FIG. 3 is a diagram showing a perspective view of a main body of a drive recorder.

FIG. 4 is a diagram schematically showing an example of the external view of a reproduction device.

FIG. 5 is a block diagram showing an example of an electric configuration of a drive recorder.

FIG. 6 is a block diagram showing an example of an electric configuration of a power source control circuit.

FIG. 7 is a block diagram showing an example of an electric configuration of a reproduction device.

FIG. 8 is a diagram showing an example of a flow chart of the division processing of the continuously recorded image.

FIG. 9 is a diagram showing the structure of a continuously recorded image data file by way of example.

FIG. 10 is a diagram showing an example of a flow chart of listing operations of the events of the continuously recorded image data file.

FIG. 11 is a diagram showing a flow chart of the selecting and storing operations of the continuously recorded image data file.

### DETAILED DESCRIPTION OF THE PREFERRED EMBODIMENT

Embodiments of the methods of processing the continuously recorded image of the present invention are explained in detail below with reference to the drawings. It is understood that the scope of the present invention is not limited to these embodiments, and extends to the invention described in the claims and their equivalents. Various modifications to the present invention can be also implemented within a range which does not deviate from the gist of the present invention.

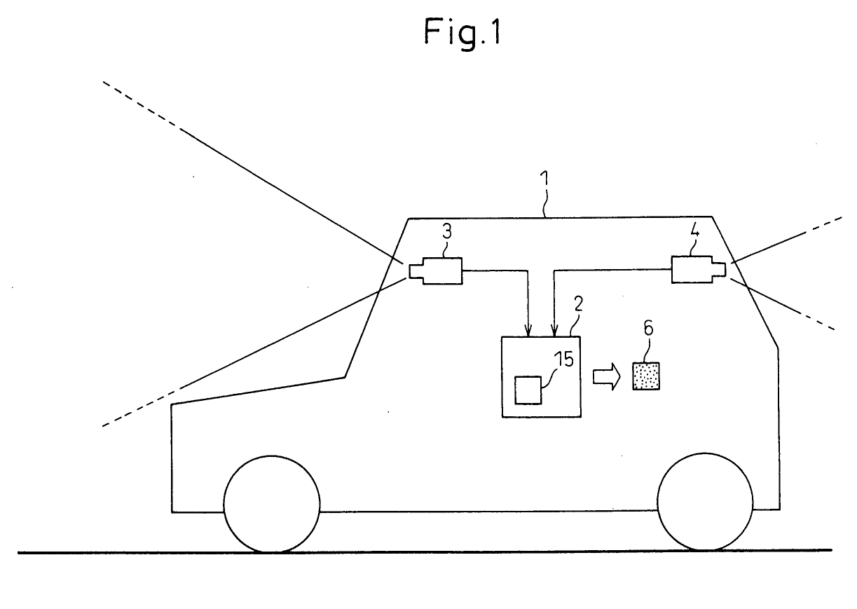

First, the recording of information in a drive recorder is explained. FIG. 1 is a diagram showing an example of a drive recorder 2 mounted on a vehicle 1. The drive recorder 2 is installed in the vehicle 1, and is connected to a first camera 3 that records an image of the front of the vehicle 1 and a second camera 4 that records an image of the back of the vehicle 1. Image information picked up by the first camera 3 and the second camera 4 is continuously recorded in a semiconductor memory unit 15 within the drive recorder 2. The image information stored in the semiconductor memory unit 15 is recorded onto a memory card 6.

The drive recorder 2 obtains the operating information of the vehicle including the vehicle speed information in addition to the image information, and continuously stores the information into the semiconductor memory unit 15 within the drive recorder 2. The operating information is associated with the image information and recorded together onto the memory card 6. The details of the operating information is described later.

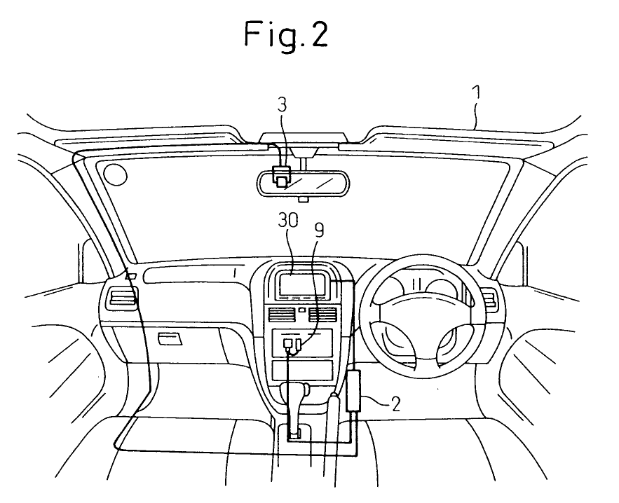

FIG. 2 shows an example of the drive recorder 2 installed in the vehicle 1. The drive recorder 2 is, for example, fixed on the end of the center panel below the left side of the handle, and electrically connected to the first camera 3 (and the second camera 4 not shown in FIG. 2), a GPS sensor 9, a vehicle speed sensor 10 not shown in the FIG. 2, a battery 21 not shown in FIG. 2, a vehicle mounted display unit 30, etc. The first camera 3 is attached to a front glass surface on the back side of a mirror within the vehicle, takes an image of the front of the vehicle, and transmits the image information to the drive recorder 2.

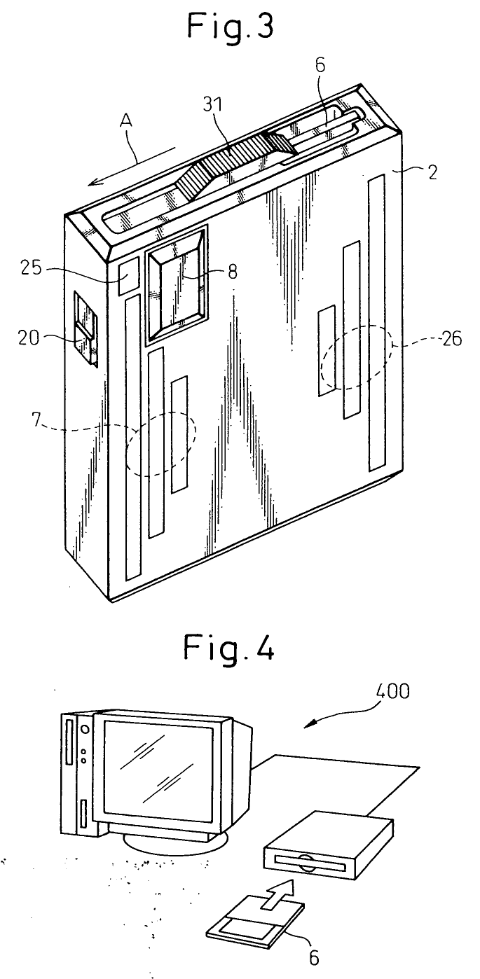

FIG. 3 shows a perspective view of the main body of the drive recorder 2. The drive recorder 2 has a microphone 7, an imaging switch 8, a power source switch 20, an LED 25, a buzzer 26, an open/close sensor 27 not shown in FIG. 3, and an open/close slider 31. The microphone 7 collects voices and sound within the vehicle 1. The imaging switch 8 is adapted to input various information for initialization of the drive recorder 2. The LED 25 and the buzzer 26 have functions to inform the user of the state of the drive recorder 2 by emitting light and issuing an alarm.

After the memory card 6 is inserted into a slot forming an I/F 11, which is discussed hereinafter, the open/close slider 31 is slid on the slot to protect the memory card 6 (FIG. 3). When the memory card 6 is removed, the open/close slider 31 is in the direction of arrow “A”. The drive recorder 2 has an open/close sensor 27 associated with the open/close slider 31, and is configured to output an OFF signal which indicates that the open/close slider 31 is closed and slid over the memory card 6 (FIG. 3) and outputs an ON signal which indicates that the slider is moved to an open position and the memory card 6 can be removed.

FIG. 4 shows an example of a reproduction device. A reproduction device 400 configured by a personal computer and the like reproduces the image information recorded onto the memory card 6. The memory card 6 is inserted into an interface connected to the personal computer, and the image information and the operating information are read out. A user can identify the running state of the vehicle and the cause of an accident by verifying the image information and the operating information.

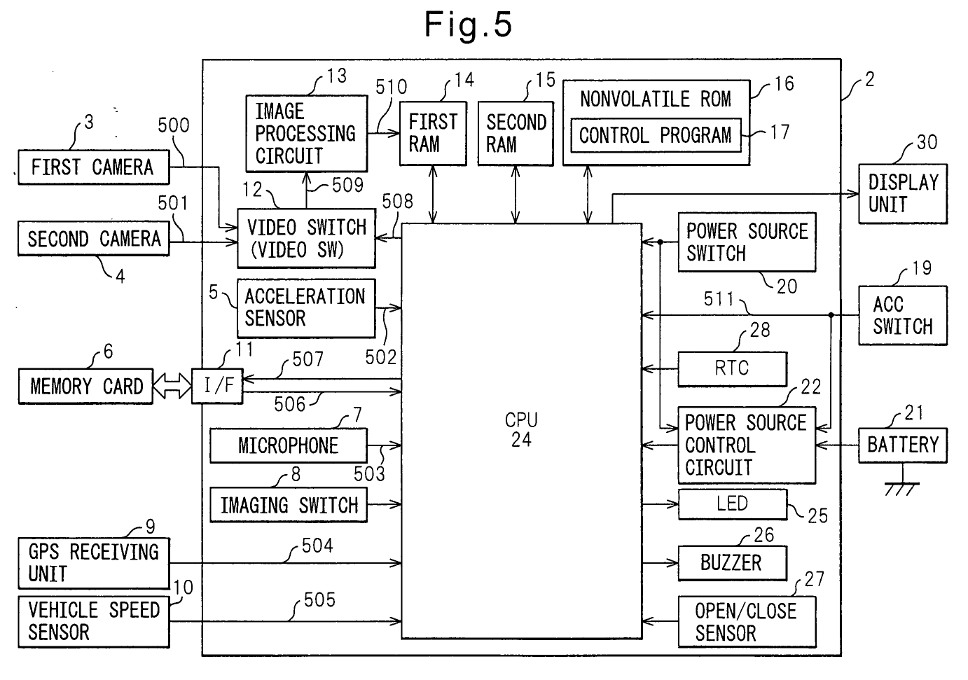

FIG. 5 is a block diagram showing an electric configuration of the drive recorder 2. The first camera 3 is controlled to image the front of the vehicle 1 and output an analog video signal as first image information 500, and includes a CCD image sensor (Charge Coupled Device Image Sensor) and a CMOS image sensor (Complementary Metal Oxide Semiconductor Image Sensor) as a two-dimensional image sensor.

The second camera 4 is in the vehicle 1 and is controlled to take an image of the back of the vehicle and the inside of the vehicle in a direction different from that of the camera 3, and output an analog video signal as the second image information 501. If only one camera is necessary, the second camera 4 does not need to be connected.

The acceleration sensor 5 includes what is known as a G sensor (Gravity Accelerative Sensor) which detects the size of a shock applied to the vehicle 1 as a gravitational acceleration. The acceleration sensor 5 includes semiconductors generating a current based on the gravitational acceleration when an impact is received. The acceleration sensor 5 detects the size of the gravitational acceleration in the front and rearward directions and the left and right directions of the vehicle, and outputs gravitational acceleration information 502 to a CPU 24.

The memory card 6 is a recording medium removable from the drive recorder 2, and includes an SD card (Secure Digital memory Card) as a programmable nonvolatile semiconductor memory card. Image information and operating information are recorded onto the memory card 6. An ID of a vehicle, a specified ID of the memory card 6, data of an ID or the name of a user (for example, a taxi driver) who uses the memory card 6 are recorded separately onto the memory card 6. Furthermore, the memory card 6 has a dip switch which is operated to prohibit writing to the memory card 6.

While an SD card is used as an removable recording medium in the present embodiment, the removable recording medium is not necessarily limited to this, and a separate removable memory card (for example, CF card (Compact Flash Card) or memory stick) and hard disk can be also used. In place of the memory card 6, the drive recorder 2 can be incorporated with a hard disk. In this arrangement, a transmission circuit is provided in the drive recorder 2, and the image information and the operating information recorded on the hard disk can be transmitted to the reproduction device 400 by radio communication.

The microphone 7 is electrically connected to the CPU 24, and is configured to collect voices and sound within or outside the vehicle 1 and transmit the collected sound as sound information 503 to the CPU 24. An analog/digital converter within the CPU 24 converts the sound information 503 into a digital signal. It is preferable to use a unidirectional microphone having high sensitivity in front part of the microphone so as not to record unnecessary noise on the road.

The imaging switch (imaging SW) 8 is operated by the user, and transmits a signal to the electrically connected CPU 24. Accordingly, the CPU 24 controls the image information and the operating information stored in a second RAM 15 onto the memory card 6. Alternatively, only the momentary image information when the imaging SW 8 is operated can be recorded onto the memory 6.

A GPS (Global Positioning System) receiving unit 9 receives a signal containing satellite tracking data and time data from a plurality of GPS satellites, calculates the relative distance difference between each satellite and the GPS receiving unit from the time difference of the received signals, and obtains the current position information of the vehicle. When radio waves emitted from three satellites are detected, the position of the vehicle on the earth's surface can be determined. Upon detecting the current position information, the GPS receiving unit 9 transmits the GPS information 504 containing the position information and the time information to the CPU 24.

A vehicle speed sensor 10 outputs a rotation of a rotor provided on a wheel axis of the vehicle 1 as a rotation pulse signal 505, and includes a magnetic sensor or an optical sensor. The CPU 24 calculates a wheel rotation number per unit time from a pulse signal received from the vehicle speed sensor 10, and calculates speed information of the vehicle 1.

The interface (I/F) 11 configures a slot of the memory card 6 provided in the drive recorder 2. The I/F 11 transfers the record information 506 containing the image information and the operating information transmitted from the drive recorder 2, to the memory card 6, and transfers the various information 507 recorded in advance in the drive recorder 2 to the CPU 24.

Video switch (hereinafter, “video SW”) 12 switches between the cameras that take images when a plurality of cameras are provided. In the present embodiment, the first camera 3 and the second camera 4 are connected to the video SW 12. The video SW 12 is configured to select one camera based on a selection signal 508 from the CPU 24, and output the image information from the selected camera as selection image information 509 to an image processing circuit 13. The video SW 12 can also be configured to have a clock function and switch between the cameras at a constant time interval.

An image processing circuit 13 converts the selection image information 509 input from the first camera 3 and the second camera 4 via the video SW 12 through to the digital signal, and generates and outputs the image data 510. The image processing circuit 13 includes a JPEG-IC (Joint Photographic coding Experts Group-Integrated Circuit), and generates data in a JPEG format. In this embodiment, the JPEG-IC does not have a function of outputting data by assigning an address. Therefore, the image processing circuit 13 writes 30 data files into a first RAM (Random Access Memory) 14 each second, and then overwrites each data file.

The first RAM 14 temporarily stores the image data 510 converted by the image processing circuit 13. The first RAM 14 is connected to a DMA (Direct Memory Access) circuit within the CPU 24.

The second RAM 15 continuously stores the image information converted into the image data by the image processing circuit 13, and the operating information. An SDRAM (Synchronous Dynamic Random Access Memory) is used, for example for the first RAM 14 and the second RAM 15. SDRAM is designed to operate synchronously with the clock of the CPU. Therefore, the SDRAM has short input-and-output times, and can be accessed faster than a conventional DRAM (Dynamic Random Access Memory). Consequently, SDRAM is suitable for controlling processing of a large amount of image data at a high speed.

A nonvolatile ROM 16 stores a control program 17 and the like to collectively control the hardware resources constituting the drive recorder 2. A Mask ROM can be used for the nonvolatile ROM 16. When a flash memory, an EEPROM (Erasable Programmable Read Only Memory) or a ferroelectric memory, which are programmable non volatile semiconductor memories, are used for the nonvolatile ROM 16, a program can be written onto and erased from the nonvolatile ROM.

A control program 17 is stored in the nonvolatile ROM 16, and is read by the CPU 24 at the time the drive recorder 2 is started. The control program 17 functions as a program to control each unit and perform data process. An ACC switch 19 is electrically integrated with an engine-start key switch provided in the vehicle 1. When the user turns the key switch, the ACC switch 19 transmits an accessory-on signal 511 to the CPU 24 and a power source control circuit 22 of the drive recorder 2. When the drive recorder 2 receives the accessory-on signal 511 from the ACC switch 19, the power source from the power source control circuit 22 is supplied to the CPU 24 of the drive recorder 2, whereby the control begins. In place of the output signal of the ACC switch 19, an ignition key output signal (IG-on signal) can be also used.

When the user turns the switch, a power source switch (power source SW) 20 transmits a power-on signal to the CPU 24 and a power source control circuit 22 of the drive recorder 2. The power source SW 20 can be used when it is desirable to operate the drive recorder without turning on the ACC switch 19. The power source SW 20 can be turned off by means of software through an ACC off timer which is not shown.

The battery 21 is provided in the vehicle 1, and supplies electric power to the main body of the drive recorder 2. The battery also supplies electric power to a power source control circuit 22. The battery 21 can be any battery that can be installed in the vehicle and can generate 12V. The power source control circuit 22 supplies electric power from the battery 21 to the CPU 24 and the each component contained in the drive recorder 2. The power source control circuit 22 is described in more detail later.

The CPU (Central Processing Unit) 24 operates as a control device of the drive recorder 2, and includes a microcomputer and the like. The CPU 24 controls the components contained in the drive recorder 2 and calculates the data based on the control program 17.

The LED 25 is configured to turn the light on and to notify the user that the drive recorder 2 is being activated, when the drive recorder 2 is supplied with electric power from the CPU 24 and is activated. When an abnormality occurs in the drive recorder 2, the LED 25 blinks under the control of the CPU 24 to notify the user of the abnormality.

The buzzer 26 is configured to generate an alarm under the control of the CPU 24 to notify the user of an abnormality. The open/close sensor 27 is configured to output the open-state signal and the closed-state signal according to the movement of the open/close knob 31 associated with the insertion and the extraction of the memory card 6. An RTC (Real Time Clock) 28 generates a signal corresponding to the present time, and transmits the signal to the CPU 24.

The display unit 30 includes a liquid-crystal display unit or the like, and displays the image information recorded onto the memory card 6. In FIG. 2, a display of a navigation device installed in the vehicle is used as the display unit 30, but alternatively, a separate display can be also used as the display unit 30. When an accident occurs, the cause of the accident can be verified at the accident site utilizing the display unit 30. It is preferable that the drive recorder 2 be provided with an output port to output the image information.

The drive recorder 2 can be integrally accommodated in the same casing together with the first camera 3, the second camera 4, the GPS receiving unit 9, and/or the display unit 30, as a dedicated image recording device. Alternatively, the drive recorder 2 can be configured as one of the functions of a vehicle-mounted navigation device.

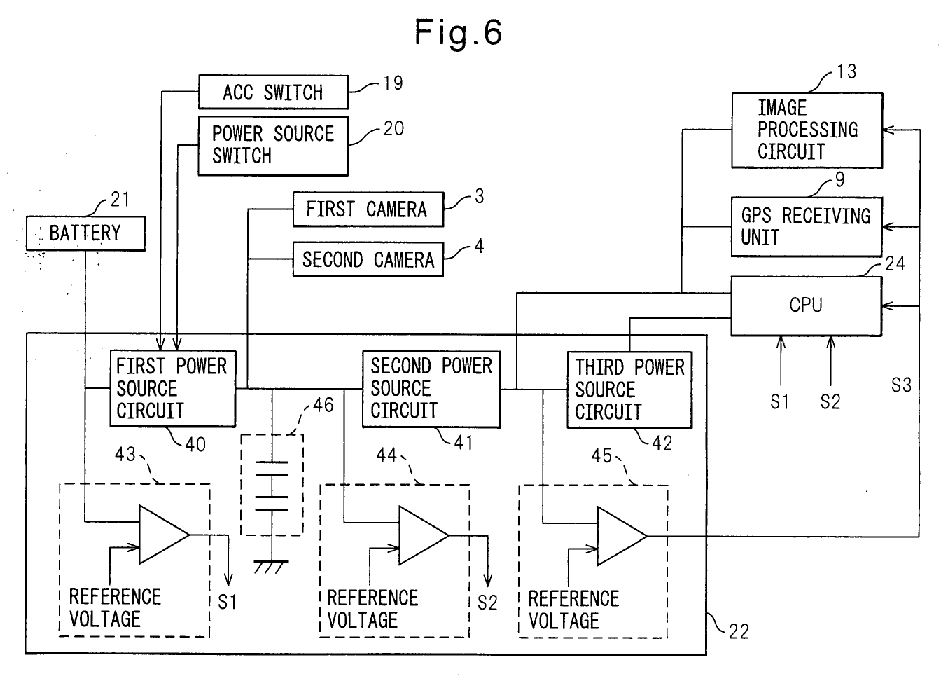

FIG. 6 shows a block diagram of an electric configuration of the power source control circuit 22. The power source control circuit 22 includes a first power source circuit 40, a second power source circuit 41, a third power source circuit 42, a first detection unit 43, a second detection unit 44, a third detection unit 45, and a backup battery 46.

The first power source circuit 40 starts operating when the ACC switch 19 or the power source SW 20 is turned on, receives the electric power from the battery 21 rated at 12.0 V, and functions as a 6.0 V constant voltage power supply source. The output of the first power source circuit 40 is supplied to the first camera 3 and the second camera 4.

The second power source circuit 41, receives the electric power from the first power source circuit 40 rated at 6.0 V, and functions as a 3.3 V constant voltage power supply source. The output of the second power source circuit 41 is supplied to the JPEG circuit which constitutes the image processing circuit 13, the GPS receiving unit 9, and the CPU 24.

The third power source circuit 42 receives the electric power from the second power source circuit 41 rated at 3.3 V, and functions as a 1.8 V constant voltage power supply source. The output of the third power source circuit 42 is supplied to the CPU 24.

The first detection circuit 43 detects the output voltage of the battery 21, and outputs a first voltage reduction signal S1 to the CPU 24 when the value of the output voltage of the battery 21 is reduced to 8.0 V. The second detection circuit 44 detects the output voltage of the first power source circuit 40, and outputs a second voltage reduction signal S2 to the CPU 24 when the value of the output voltage of the first power source circuit 40 is reduced to 3.7 V. The third detection circuit 45 detects the output voltage of the second power source circuit 41, and outputs a reset signal S3 to the JPEG circuit which constitutes the image processing circuit 13, the GPS receiving unit 9, and the CPU 24 to reset each element to thereby prevent malfunction due to voltage reduction when the value of the output voltage of the second power source circuit 41 is reduced to 3.0 V.

The backup battery 46 is comprised of two capacitors, and is configured to supply the electric power necessary to operate the JPEG circuit which forms the image processing circuit 13, the GPS receiving unit 9, and the CPU 24, for a predetermined time when the output voltage of the battery 21 is reduced. When an impact occurs due to a collision or the like, there is a risk that the battery 21 may be damaged or the battery 21 and the power source control circuit 22 may become disconnected. If this occurs, the image information which is being processed can be saved by supplying the stored power to the CPU 24 from the backup battery 46.

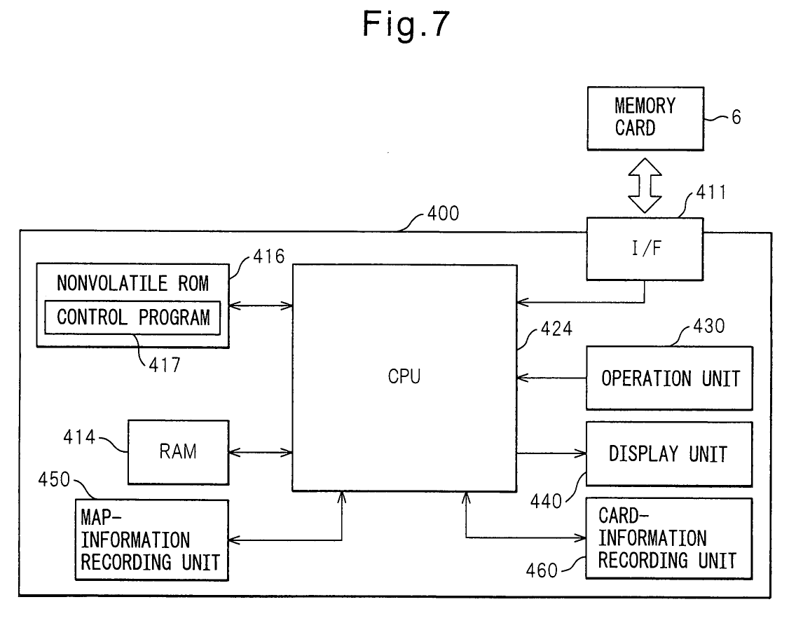

FIG. 7 is a block diagram showing an electric configuration of the reproduction device 400. An interface (I/F) 411 configures an entry of the memory card 6, which is known as a slot unit, provided in the reproduction device 400. The I/F 411 transfers the image information and the operating information recorded onto the memory card 6 to the reproduction device 400.

A RAM 414 is used to temporarily store data when a CPU 424 processes the image information and the information processing of the operating information transferred from the memory card 6. An SDRAM is used for example as the RAM 414.

A nonvolatile ROM 416 stores a control program 417 and the like to collectively control hardware resources constituting the reproduction device 400. An EEPROM and a ferroelectric memory are used as the nonvolatile ROM 16.

A control program 417 is stored in the nonvolatile ROM 416, and is read by the CPU 424 when starting the reproduction device 400. The control program 417 functions as a program to control each unit and perform the data processing.

A CPU 424 as a computer controls the reproduction device 400, and includes a microcomputer and the like. The CPU 424 controls the components of the reproduction device 400 and processes the data based on the control program 417.

An operation unit 430 is configured by a keyboard, a mouse and the like, and is used to input the data to the CPU 424 when the user operates the reproduction device 400. A display unit 440 is configured by a liquid crystal display unit and the like, and is used to appropriately display the image information and the operating information recorded onto the memory card 6.

A map-information recording unit 450 is configured by recording medium such as a hard disk or a DVD, and contains map information, including road information and speed limit information recorded therein. A card-information recording unit 460 is configured by recording medium such as a hard disk, and is used to record the image information and the operating information recorded onto the memory card 6.

The operating information includes the following information.
1. The information regarding gravitational acceleration (G1, G2) detected from each axis of the acceleration sensor 5.
2. The information regarding the position of the vehicle 1 and the time information detected from the GPS receiving unit 9.
3. The information regarding the speed detected from the vehicle speed sensor 10.
4. The information regarding the ON/OFF state of the ACC switch 19.

Content of the operating information is not necessarily limited to the above information, and the operation information can also contain information of the light, an indicator and running of the vehicle 1 such as an angle of the steering wheel.

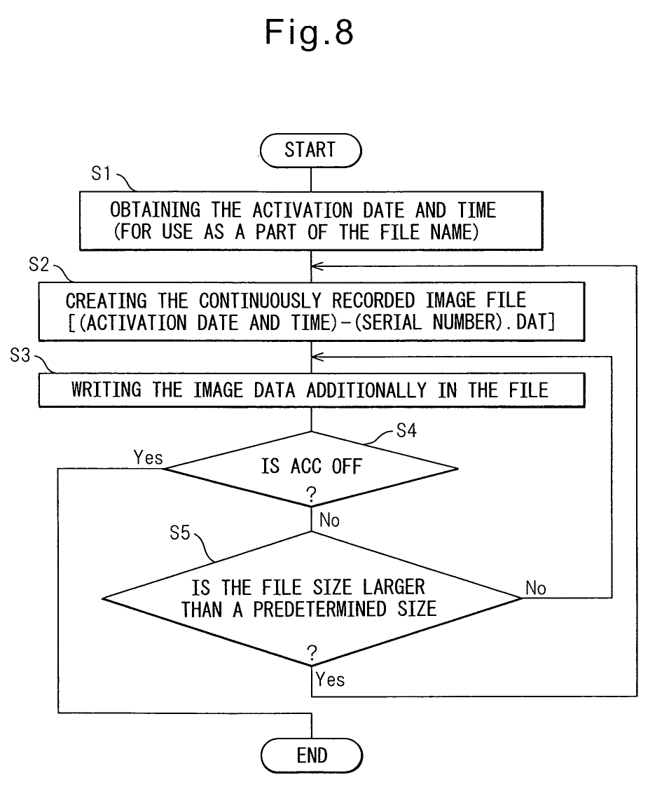

FIG. 8 shows a flow chart of the division processing of the continuously recorded image. The CPU 24 of the drive recorder 2 mainly performs the processes of the flow chart shown in FIG. 8, in cooperation with each element of the drive recorder 2 based on the control program 417. Alternatively, the CPU 424 of the reproduction device 400 may mainly perform the processes of the flow chart shown in FIG. 8, in cooperation with each element of the reproduction device 400 based on the control program 417.

The processes of the flow chart start when the continuous recording of the drive recorder 2 starts. At step S1, the CPU 24 obtains the activation date and time to be used as a part of the data file name as described below.

Next, at step S2, the CPU 24 creates the continuously recorded image data file. The continuously recorded image data file is assigned a data file name consisting of a combination of activation date and time and a serial number, such as “M081105102533-0001.dat” or “M081105102533-0002”. Next, at step S3, the CPU 24 writes the image data additionally in the data file.

Next, at step S4, the CPU 24 judges whether the ACC switch 19 is off or not. If the ACC switch 19 is off, the control ends. Conversely if the ACC switch is not off at step S4, the CPU 24 judges whether the size of the data file is more than a predetermined size at step S5. If the data file size is larger than a predetermined size, the control is returned to step S2. If the data file size is not larger than a predetermined size, the control is returned to step S3. In the process of the flow chart in FIG. 8, the data file division is performed in two stages, i.e., the data file is divided based on activation each in the first stage, so that the data file can be easily found, and the data file is divided into units of a data file size (for example, 10 Mega Bytes) in the second stage, so that when one of the data files is corrupted, the damage can be minimized.

When the continuously recorded image data file recorded on the memory 6 is indicated in the display unit 440 in the process shown in FIG. 8, the continuously recorded image data file is categorized based on the data file name and is displayed as thumbnail-sized images. When the number of activations of the continuously recorded image file is numerous, the continuously recorded image data file is also categorized based on a larger unit such as date-year and is displayed. The continuously recorded image data file can be displayed as a list in place of the thumbnail-sized image. If the number of the data files in one category is numerous, it is possible to decrease the number of the files indicated as thumbnail-sized image (for example, one thumbnail-sized image is displayed by two files).

When the continuously recorded image data file is indicated as a thumbnail-sized image, the recording date, the vehicle speed at the time of recording, the value of G, the position coordinates representing the vehicle, the position of the vehicle shown on a map and the state of the vehicle, such as empty or occupied can be displayed at once. It is also possible to indicate the traffic violation items, the icon of the traffic violation items and the number of traffic violation items recorded in the continuously recorded image data file at once together with the thumbnail-sized image of the continuously recorded image data file. Furthermore, it is possible to indicate the maximum speed, the maximum value of G and the recording time recorded in the continuously recorded image data file at once together with the thumbnail-sized image of the continuously recorded image data file. The continuously recorded image data file may indicate either a list of data recorded onto the memory card 6 or a list of data recorded onto the single or plural memory cards 6 stored in the card-information recording portion 460 in the display unit 440.

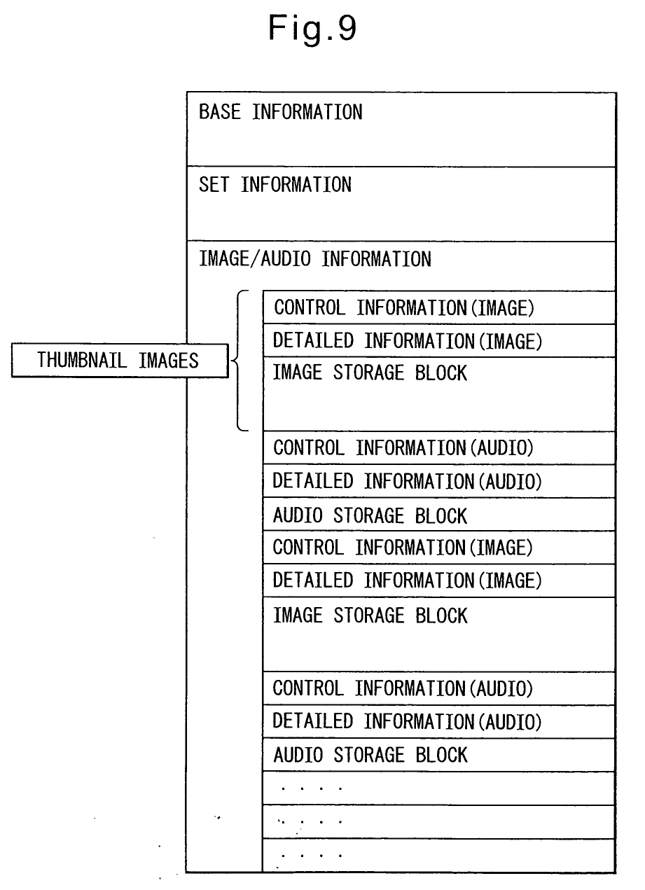

FIG. 9 shows an example of the configuration of the continuously recorded image data file. The recorded image data file shown in FIG. 9 includes base information, set information, and image/audio information. Items of the base information includes an item of the type of the trigger representing whether the image is taken by detecting the value of G or switching operation whether the image has been continuously recorded, an item of the date when the trigger occurred, an item of the lapse of time (Time Stamp) from the starting of the operation of the vehicle-mounted device (device recorder), an item of the value of G detected by the acceleration sensor, an item of speed of the vehicle, an item of the coordinates of the vehicle position obtained from the GPS, an item of the states of the ACC switch, and the external input port and the like, and an item of the cumulative travel distance of the vehicle from the activation of the vehicle-mounted device.

The image/audio information includes a plurality of thumbnail-sized images consisting of control information, detailed information, and image and audio storage blocks. The image storage block and the audio storage block are not necessarily arranged alternately, and the image data file and the audio only data file can be discriminated by the set information and the triggering type. The thumbnail-sized image corresponds to the latest stored image when the trigger is detected.

Item of the control information includes an item of the block size of the image storage block and the audio storage block, an item of the lapse of time (Time Stamp) from the start of the operation of the vehicle-mounted device (device recorder), an item of the actual data size, and ID for identifying whether the information is the image information or the audio information. Items of the detailed data information includes an item of the date when the trigger occurred, an item of speed of vehicle, an item of the coordinates of the vehicle portion obtained from the GPS, an item of the type of the event, such as rapid acceleration and the like, an item of the state of the ACC switch and the external input port, etc., an item of the accumulated travel distance of the vehicle from the activation of the vehicle-mounted device. In case of the image information, items of the information further includes an item of the camera number and item of the image numbers which are the serial numbers given to the image frames.

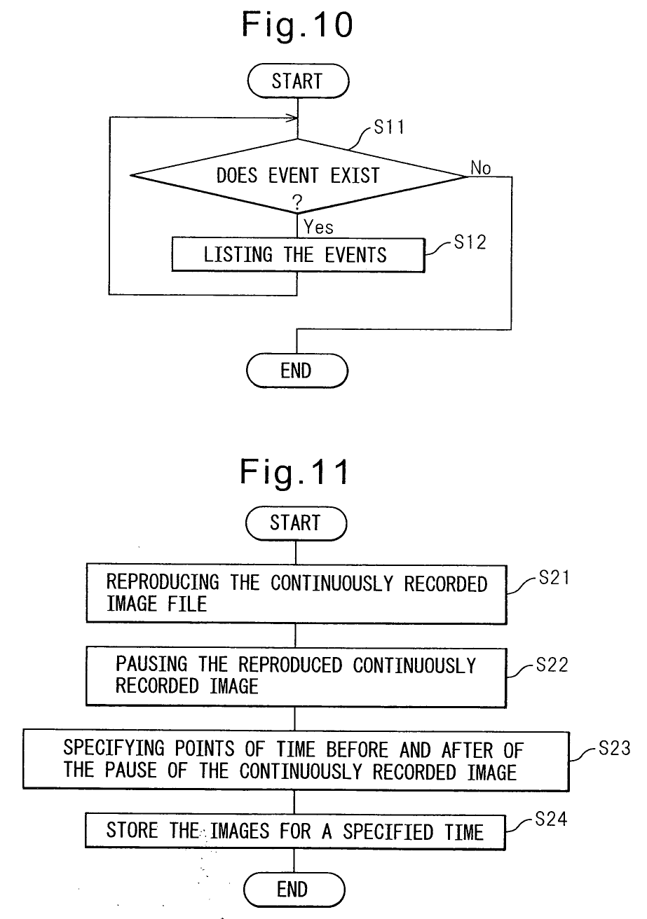

FIG. 10 shows a flow chart listing the events of the continuously recorded image data file. The CPU 424 of the reproduction device 400 mainly performs the operations of the flow chart shown in FIG. 10, cooperating with each element of the reproduction device 400, based on the control program 417, in connection with or independently of the operations of the flow chart shown in FIG. 8.

The process of the flow chart shown in FIG. 10 begins when the CPU 400 obtains the continuously recorded image data file information shown in FIG. 9 from the card information recording unit 460. First at step S11, the CPU 424 judges whether an event which is not listed, exists in the continuously recorded image data file or not. If an event which is not listed exists in the continuously recorded image data file, the CPU 424 lists the events at step S12 and returns to step S11. If an event which is not listed does not exist in the continuously recorded image data file, the process of the flow chart ends and the event list is indicated on the display unit 440 together with information (date, triggering, etc.) of each event. The events within the list of the events are sorted by date and displayed. Consequently, a user can find the events which are included in the image data which is being reproduced, and thus, can obtain the information of each event.

When an event within the list of the events is selected by the operation of the operation unit 430 (for example, clicking a mouse), the CPU 424 starts reproduction the image from an image portion recorded several seconds before the time of the occurrence of the selected event. An operation button for reproducing the image from an image portion recorded several seconds before the time of the occurrence of the event subsequent to the selected event can be provided in the display unit 440, whereby movement of the image between the events can be easily carried out.

The CPU 424 creates a time chart on which the events of the continuous recorded image data file are marked, so that when a mark of the event is selected, the image can be reproduced at an image portion recorded several seconds before the time of the occurrence of the selected event. Also, the CPU 424 creates a map on which the events of the continuous recorded image data file are marked, so that when a mark of the event is selected, the image can be reproduced at an image portion recorded several seconds before the time of the occurrence of the selected event. In this embodiment, the CPU 424 may list the number of the upper values of G among the detected values of G. If the images over two continuously recorded image data files are reproduced, the CPU 424 reproduces the images with reference to the continuously recorded image data files to be reproduced and the set time data.

FIG. 11 shows a flow chart of selecting and saving the continuously recorded image data file. The CPU 424 of the reproduction device 400, mainly performs the processes of the flow chart shown in FIG. 11, cooperating with each element of the reproduction device 400, based on the control program 417, in connection with at least one or independently of the process of the flow chart shown in FIG. 8 and the process of the flow chart shown in FIG. 10.

In the flow chart shown in FIG. 11, the CPU 424, first, at step S21, reproduces the continuously recorded image data file in the display unit 440, according to the operation of the operation unit 430. Thereafter, at step S22, the CPU 424 gives a pause to the reproduced image at a desired point of time for saving according to the operation of the operation unit 430.

After that, at step S23, the CPU 424 specifies the range between a point of time before a first time length from the temporary pause and a point of time after a second time length from the temporary pause. A sliding bar displayed on the display unit 440 can be used to specify the range. The first time period and the second time period can be the same or different from one another. If the frame rate in the continuous recording is variable, it is preferable that the first time period and the second time period be made different from one another, depending on the frame rate, i.e., it is preferable that the specifiable maximum value be varied depending on the frame rate, because the recording capacity for the same recording time differs according to the frame rate.

Next, at step S24, the CPU 424 stores the images for the specified time in the RAM 414 and the process of the flow chart ends. The continuously recorded image contains a large amount of data of several Giga Bytes, so the capacity of the RAM 414 quickly runs short. By narrowing the range for the continuously recorded images to be stored in the process of the flow chart shown in FIG. 11, it is possible to store a large number of events in the RAM 414.

What is claimed is:

1. A method of processing a continuously recorded image, with the use of a computer, comprising the steps of:
judging whether a continuously recorded image is recorded at a certain interval, and
storing the continuously recorded image as a data file when the continuously recorded image is recorded at a certain interval.

2. The method according to claim 1, wherein a certain interval corresponds to an activation time of the vehicle.

3. A method of processing a continuously recorded image, with the use of a computer, comprising the steps of:
extracting events of a continuously recorded image recorded by a vehicle-mounted device, and
making a list of the events.

4. The method according to claim 3, further comprising the step of:
reproducing the continuously recorded image at an image portion for an event recorded several seconds before the time of the occurrence of the selected event at the time of selecting one of the event in the list of the events.

5. The method according to claim 3, further comprising the steps of:
making a time chart on which the events are marked, and
reproducing the continuously recorded image at an image portion for an event recorded several seconds before the time of the occurrence of the selected event at the time of selecting one the marks of the event.

6. The method according to claim 3, further comprising the steps of:
making a map on which the events are marked, and
reproducing the continuously recorded image at an image portion for an event recorded several seconds before the time of the occurrence of the selected event at the time of selecting one the marks of the event.

7. The method according to claim 3, further comprising the steps of:
making a list of values of G above a predetermined value detected when the image is continuously recorded, and
reproducing the continuously recorded image at an image portion for an event recorded several seconds before the time of the occurrence of the selected event at the time of selecting one the values of G.

8. The method according to claim 3, further comprising the steps of:
reproducing the continuously recorded image,
temporarily pausing the continuously recorded image,
specifying a range between a point of time before a first time length form the temporary pause and a point of time after a second time length from the temporary pause, and
saving the continuously recorded image included in the specified range.

9. A computer-readable medium for processing a continuously recorded image, with the use of a computer, comprising the steps of:
judging whether a continuously recorded image is recorded at a certain interval, and
storing the continuously recorded image as a data file when the continuously recorded image is recorded at a certain interval.

10. The medium according to claim 9, wherein a certain interval corresponds to an activation time of the vehicle.

11. A computer-readable medium for processing a continuously recorded image, with the use of a computer, comprising the steps of:
extracting events of a continuously recorded image recorded by a vehicle-mounted device, and
making a list of the events.

12. The medium according to claim 11, further comprising the step of:
reproducing the continuously recorded image at an image portion for an event recorded several seconds before the time of the occurrence of the selected event at the time of selecting one of the event in the list of the events.

13. The medium according to claim 11, further comprising the steps of:
making a time chart on which the events are marked, and
reproducing the continuously recorded image at an image portion for an event recorded several seconds before the time of the occurrence of the selected event at the time of selecting one the marks of the event.

14. The medium according to claim 11, further comprising the steps of:
making a map on which the events are marked, and
reproducing the continuously recorded image at an image portion for an event recorded several seconds before the time of the occurrence of the selected event at the time of selecting one the marks of the event.

15. The medium according to claim 11, further comprising the steps of:
making a list of values of G above a predetermined value detected when the image is continuously recorded, and
reproducing the continuously recorded image at an image portion for an event recorded several seconds before the time of the occurrence of the selected event at the time of selecting one the values of G.

16. The medium according to claim 11, further comprising the steps of:
reproducing the continuously recorded image,
temporarily pausing the continuously recorded image,
specifying a range between a point of time before a first time length form the temporary pause and a point of time after a second time length from the temporary pause, and
saving the continuously recorded image included in the specified range.

17. A drive recorder comprising a computer for processing a continuously recorded image:
the computer judging whether a continuously recorded image is recorded at a certain interval, and storing the continuously recorded image as a data file when the continuously recorded image is recorded at a certain interval.

18. The computer according to claim 17, wherein a certain interval corresponds to an activation time of the vehicle.

19. A reproduction device comprising a computer for processing a continuously recorded image:
the computer extracting events of a continuously recorded image recorded by a vehicle-mounted device, and making a list of the events.

20. The reproduction device according to claim 19, wherein the computer reproduces the continuously recorded image at an image portion for an event recorded several seconds before the time of the occurrence of the selected event at the time of selecting one of the event in the list of the events.

21. The reproduction device according to claim 19, wherein the computer makes a time chart on which the events are marked, and reproduces the continuously recorded image at an image portion for an event recorded several seconds before the time of the occurrence of the selected event at the time of selecting one the marks of the event.

22. The reproduction device according to claim 19, wherein the computer makes a map on which the events are marked, and reproduces the continuously recorded image at an image portion for an event recorded several seconds before the time of the occurrence of the selected event at the time of selecting one the marks of the event.

23. The reproduction device according to claim 19, wherein the computer makes a list of values of G above a predetermined value detected when the image is continuously recorded, and reproduces the continuously recorded image at an image portion for an event recorded several seconds before the time of the occurrence of the selected event at the time of selecting one the values of G.

24. The reproduction device according to claim 19, wherein the computer reproduces the continuously recorded image, temporarily pauses the continuously recorded image, specifies a range between a point of time before a first time length form the temporary pause and a point of time after a second time length from the temporary pause, and saves the continuously recorded image included in the specified range.
